(19) United States
(12) Patent Application Publication
(10) Pub. No.: US 2023/0031052 A1
(43) Pub. Date: Feb. 2, 2023

(54) FEDERATED LEARNING IN COMPUTER SYSTEMS

(71) Applicant: INTERNATIONAL BUSINESS MACHINES CORPORATION, ARMONK, NY (US)

(72) Inventors: Jordan McAfoose, Schaffhausen (CH); Adelmo Cristiano Innocenza Malossi, Schönenberg (CH); Mathieu Sinn, Dublin (IE)

(21) Appl. No.: 17/443,840

(22) Filed: Jul. 28, 2021

(51) Int. Cl. G06N 20/20; G06N 5/04; G06F 11/34

(52) U.S. Cl. CPC G06N 20/20; G06N 5/043; G06F 11/3495

(57) ABSTRACT

Methods and systems are provided for federated learning among a federation of machine learning models in a computer system. Such a method includes, in at least one node computer of the system, deploying a federation model for inference on local input data samples at the node computer to obtain an inference output for each data sample, and providing the inference outputs for use as inference results at the node computer. The method further comprises, in the system, for at least a portion of the local input data samples, obtaining an inference output corresponding to each local input data sample from at least a subset of other federation models, and using the inference outputs from the federation models to provide a standardized inference output corresponding to an input data sample at the node computer for assessing performance of the model deployed at that computer.

### BACKGROUND

The present invention relates generally to federated learning in computer systems. Methods for model-based federated learning are provided, together with computer systems implementing such methods.

Federated Learning (FL) refers generally to machine learning techniques in which a set of participants cooperate in a machine learning process in order to benefit from heterogeneous, often geographically dispersed, data available to the individual participants. Machine learning (ML) is a cognitive computing technique in which a dataset of training samples from some real-world application is processed in relation to a basic model for the application in order to train, or optimize, the model for the application in question. After learning from the training data, the trained model can be applied to perform inference tasks based on new (previously unseen) data samples for the application. ML techniques are used in numerous applications in science and technology, including medical diagnosis, image analysis, speech recognition/natural language processing, genetic analysis and pharmaceutical drug design, among a great many others.

Performance of ML models is highly dependent on the size and diversity of the training datasets. However, movement of data is increasingly restricted by data privacy regulations and security issues, inhibiting distribution of data for training ML models. This is a significant problem where distributed parties, each with their own silo of training data, wish to cooperate and benefit from each other's training data. FL provides techniques to address such issues.

Conventional FL provides a distributed learning process in which the participating computers (i.e., node computers), each with a local training data silo, can interact to build a common, robust ML model without sharing their local training data. During training, updates to the parameters of local models, trained on local datasets, are aggregated to produce a global model which is then distributed to all nodes for further training. For example, IBM® Federated Learning (IBM FL) (IBM and all IBM-based trademarks and logos are trademarks or registered trademarks of International Business Machines Corp. and/or its affiliates) provides state-of-the-art protocols for enterprise-grade federated learning, with plug-ins for enhancing privacy and security, such as differential privacy and secure multi-party communication. In some scenarios, however, it may not be possible or desirable for parties to build a common, shared model and/or ML models may need to be deployed at resource-constrained devices where the computationally intensive training of models is infeasible.

### SUMMARY

According to an embodiment, the present invention provides a method for federated learning among a federation of machine learning models in a computer system. The method includes, in at least one node computer of the system, deploying a federation model for inference on local input data samples at that node computer to obtain an inference output for each data sample, and providing the inference outputs for use as inference results at that node computer. The method further comprises, in the system, for at least some of the data samples, obtaining an inference output corresponding to each data sample from each of at least a subset of the other federation models, and using the inference outputs from the federation models to provide a standardized inference output corresponding to an input data sample at the node computer for assessing performance of the model deployed at that computer.

Also, according to an embodiment, the invention provides a computer system for implementing a federated learning method described above.

Embodiments of the invention offer model-based FL methods/systems in which performance of a pre-trained federation model, which is actively deployed for inference on local data samples at a node computer, can be assessed using a standardized inference output for those samples. The standardized inference output, which can be produced in various ways explained below, is obtained by using inference outputs from other models in the federation, and thus provides a federation-based standard for assessing inference results at a given node. Inference results for data samples at a node computer can be assessed on a sample-by-sample basis. This provides a basis for various actions, detailed below, to be taken to ensure appropriate performance at a node computer and to share learning between the federation models.

Embodiments can be implemented with pre-trained models, permitting use with node computers in which training of models is restricted or infeasible, without requiring access to the original training data. For example, node computers of the system may comprise edge devices in a data communications network. Such edge devices may, for example, comprise mobile phones, personal computing devices, IoT (Internet of Things) sensors or other IoT devices which may have limited compute resources and/or need to function offline where necessary.

Different federation models may be deployed for inference at different node computers, while maintaining a required performance standard throughout. Embodiments can address scenarios in which different parties wish to maintain security of the parties' own ML models while still benefiting from each other's learning. For example, competing companies may wish to mutually benefit from each other's learning based on different training datasets, without sharing those datasets or their local models. Embodiments can also address scenarios in which multiple parties need to ensure comparable model predictions while preserving data confidentiality. For example, a consortium of banks may seek to establish a multi-model performance benchmark for particular applications such as loan approval or credit risk scoring. In such cases, each party may locally train and deploy a federation model for inference at a node computer of the system, while inference results at each node can be assessed on a sample-by-sample basis in relation to a federation standard.

In some embodiments, node computers may communicate directly with other federation nodes via a data communications network. In other embodiments, the system may include a control server for communication with the node computers via a data communications network. The method may then include, at each node computer, sending to the control server inference data defining an input data sample and the inference output for that data sample at that node computer, and, at the control server, using the inference data to request an inference output corresponding to that data sample from each of at least a subset of the federation models at other node computers. The control server can then use the inference outputs from the federation models to provide a standardized inference output corresponding to an input data sample at each node computer. The control server may be implemented here by a trusted entity/regulatory authority in some embodiments. In either communications scenario, communications can be implemented in a confidential computing environment where required, such that security of confidential information is protected in operation of the system.

The standardized inference output corresponding to an input data sample may be produced as a function of the inference outputs from the federation models for that sample. As examples here, the standardized inference output may comprise one of a majority vote and an average derived from the inference outputs for a data sample. This provides a particularly simple implementation which also inhibits so-called “poisoning” of the system as discussed further below. Standardized outputs may also exploit confidence values associated with the inference outputs, where available, as illustrated by embodiments below.

Further advantageous embodiments include, at least in a preliminary operating phase of the system, using the inference outputs from the federation models corresponding to each data sample to train a further ML model, or “metamodel”, which is then included in the federation. After training the metamodel, an inference output for an input data sample may be obtained from (at least) the metamodel to provide the standardized output corresponding to that sample. By using the inference outputs of federation models for metamodel training, performance of the metamodel can be expected to exceed that of any individual model in the federation, providing a convenient federation-wide standard for assessment of all models. For example, the aforementioned control server may alert a node computer if its local inference output deviates in a predetermined manner from the standardized output. This provides an elegant system for benchmarking/regulation of federation models, e.g., in banking/insurance/financial or healthcare scenarios where mutually-consistent inference results can be critical for a federation.

Alternative embodiments may include, at a node computer deploying a federation model for inference, storing at least a subset of the other federation models, and obtaining inference outputs from each of the other stored models for local input data samples at the node computer. The inference outputs from those other models can then be used to produce the standardized inference output corresponding to each input data sample at the node computer. Here, federation nodes can use one model for active inference at that node, with other federation models operating in a “shadow mode” for obtaining a standardized output for each local inference sample. Embodiments here may also exploit features of other embodiments above, such as training and use of metamodels. Metamodels can be advantageously deployed as “challengers” to federation models in some embodiments. These and other features and advantages will be described in relation to particular embodiments below.

Embodiments of the invention will be described in more detail below, by way of illustrative and non-limiting example, with reference to the accompanying drawings.

### BRIEF DESCRIPTION OF THE SEVERAL VIEWS OF THE DRAWINGS

FIG. 1 is a schematic representation of a computer system for implementing model-based federated learning methods embodying the invention;

FIG. 2 is a generalized schematic of a computer in the FIG. 1 system;

FIG. 3 indicates basic steps of a model-based federated learning method embodying the invention;

FIG. 4 illustrates component modules of a node computer in an embodiment of the FIG. 1 system;

FIG. 5 indicates steps of a model-based federated learning method in an embodiment of the FIG. 1 system;

FIG. 6 is a schematic illustration of operation of the FIG. 5 method;

FIGS. 7 and 8 are schematics illustrating a modification to the FIG. 5 method;

FIG. 9 is a schematic illustrating operation of a node computer in an alternative embodiment of the system;

FIG. 10 indicates steps of a model-based federated learning method in a further embodiment; and

FIG. 11 is a schematic illustrating operation of the FIG. 10 method.

### DETAILED DESCRIPTION

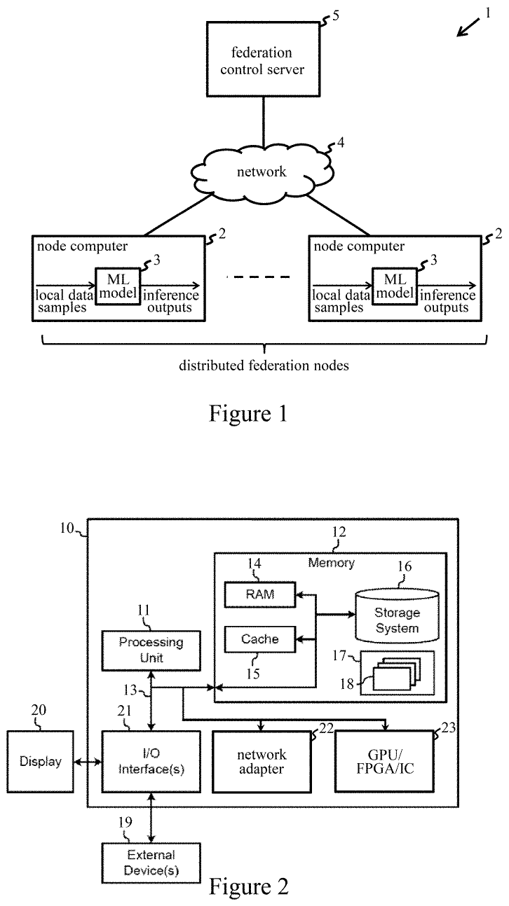

FIG. 1 shows an exemplary computer system for implementing model-based FL methods embodying the invention. The computer system 1 comprises a plurality of node computers 2, using respective local ML models 3, at a distribution of federation nodes. Each node computer 2 may communicate via a data communications network 4 to which the node computer is connected (at least intermittently) during system operation. In this example, system 1 includes a federation control server 5 for communication with node computers 2 via network 4. This network 4 may in general comprise one or more component networks (including telecommunications networks and data processing/computing networks) and/or internetworks, including the Internet.

Each ML model 3 is pretrained, either locally or prior to provision in a node computer 2, and is deployed for inference on local input data samples at the node computer. The nature of the input data samples, and the particular inference task performed, depends on the nature and function of the federation in question. ML-based inference generally falls into one of two categories, namely classification or regression. Classification tasks assign input data samples to one of a discrete set of predefined categories, or classes, and the model output for a given input sample indicates the particular class to which that sample is assigned. Regression tasks generally output a value (or value range) for some predefined continuous variable based on processing of an input sample by the model. Numerous types of federations and inference applications can be envisaged for implementation in system 1. As illustrative examples only, models may be deployed for tasks such as: image classification, e.g. for identifying particular subject matter in digital images or digital video; audio analysis, e.g. for speech recognition tasks; medical diagnosis, e.g. for classifying pathology images as diseased/healthy or evaluating severity of cancer tumors by regression analysis of tumor slides; text processing tasks, e.g. predictive text for user input devices; banking/business applications, e.g. evaluating risk for loan applications, approving insurance policies, or identifying/qualifying faults in structures in the building industry; and pharmaceutical drug selection, e.g. predicting efficacy of drugs for treatment of specific patients. Numerous other applications in technical, commercial, industrial and healthcare settings can also be envisaged.

ML models 3 may comprise any type of ML model as appropriate for the required inference task. Numerous ML models are known in the art, such as neural networks (including deep neural networks), tree-ensemble models (such as Random Forests models), Bayesian networks, SVMs (Support Vector Machines), and so on. Suitable models may be selected as appropriate for a required inference task. Note also that different models (or types of models) can be employed at different node computers where different models can perform the inference task in question.

In some applications, a node computer may comprise a general-purpose user computer such as a desktop, laptop or tablet computer. Node computers may also comprise mobile phones, smart speakers, televisions, personal music players or other such user devices. Node computers may further comprise sensors or other devices in the Internet of Things. In general, however, node computers 2 may be implemented by any type of general- or special-purpose computer, which may comprise one or more (real or virtual) machines, providing functionality for implementing the operations described herein. Federation control server 5, where provided, may similarly be operated by one or more (real or virtual) machines providing server functionality for managing operation of node computers in the federation. Such a control server may be implemented by a party running or controlling a given federation, e.g., as web server or a server operated by a regulatory authority or trusted entity for the federation. Computers 2, 5 in system 1 may also be implemented in a distributed cloud computing environments where tasks are performed by distributed processing devices linked via a communications network.

The block diagram of FIG. 2 shows an exemplary computing apparatus for implementing a computer of system 1. The apparatus is shown here in the form of a general-purpose computing device 10. The components of computer 10 may include processing apparatus such as one or more processors represented by processing unit 11, a system memory 12, and a bus 13 that couples various system components including system memory 12 to processing unit 11.

Bus 13 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 10 typically includes a variety of computer readable media. Such media may be any available media that is accessible by computer 10 including volatile and non-volatile media, and removable and non-removable media. For example, system memory 12 can include computer readable media in the form of volatile memory, such as random access memory (RAM) 14 and/or cache memory 15. Computer 10 may further include other removable/non-removable, volatile/non-volatile computer system storage media. By way of example only, storage system 16 can be provided for reading from and writing to a non-removable, non-volatile magnetic medium (commonly called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can also be provided. In such instances, each can be connected to bus 13 by one or more data media interfaces.

Memory 12 may include at least one program product having one or more program modules to carry out functions of embodiments of the invention. By way of example, program/utility 17, having a set (at least one) of program modules 18, may be stored in memory 12, as well as an operating system, one or more application programs, other program modules, and program data. Each of the operating system, one or more application programs, other program modules, and program data, or some combination thereof, may include an implementation of a networking environment. Program modules 18 may generally carry out functions and/or methodologies of embodiments of the invention as described herein.

Computer 10 may also communicate with: one or more external devices 19 such as a keyboard, a pointing device, a display 20, etc.; one or more devices that enable a user to interact with computer 10; and/or any devices (e.g., network card, modem, etc.) that enable computer 10 to communicate with one or more other computing devices. Such communication can occur via Input/Output (I/O) interfaces 21. Also, computer 10 can communicate with one or more networks such as a local area network (LAN), a general wide area network (WAN), and/or a public network (e.g., the Internet) via network adapter 22. As depicted, network adapter 22 communicates with the other components of computer 10 via bus 13. Computer 10 may also communicate with additional processing apparatus 23, such as one or more GPUs (graphics processing units), FPGAs, or integrated circuits (ICs), for implementing functionality of embodiments of the invention. It should be understood that although not shown, other hardware and/or software components could be used in conjunction with computer 10. Examples include, but are not limited to: microcode, device drivers, redundant processing units, external disk drive arrays, RAID systems and data archival storage systems, etc.

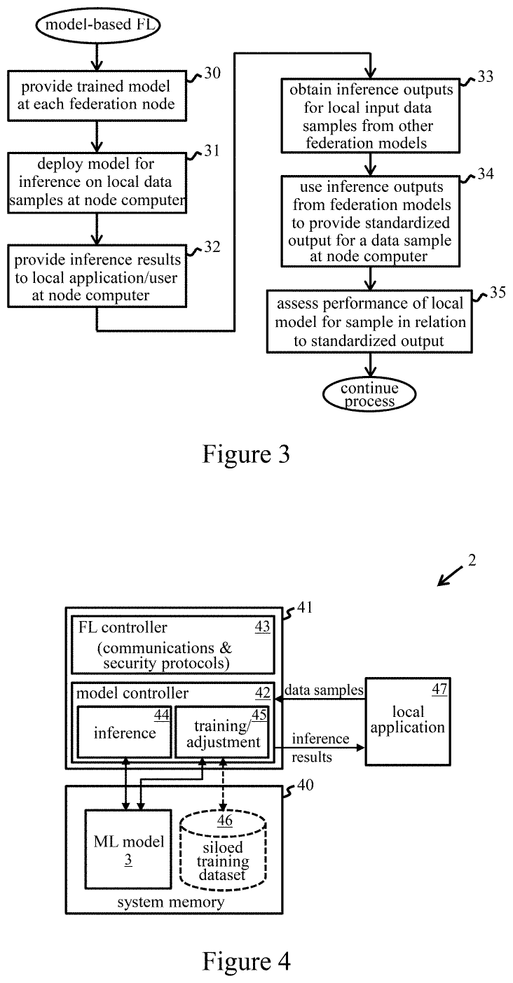

Basic steps of model-based FL methods embodying the invention are indicated in FIG. 3. Step 30 represents provision of a trained ML model 3 at each node computer 2 of federation system 1. In step 31, the model 3 is deployed for inference on local input data samples at that node computer to obtain an inference output for each data sample. These inference outputs are provided for use as inference results at that node computer (e.g., output to a user or supplied to a local application of the node) as indicated at step 32. In addition, as indicated at step 33, for at least some of these local data samples the system operates to obtain an inference output corresponding to each data sample from each of at least a subset of the other models 3 in the federation. In step 34, the inference outputs from the federation models are used in the system to provide a standardized inference output corresponding to an input data sample at the node computer. As indicated at step 35, this standardized inference output can be used to assess performance of the model deployed at the node computer. The process then continues as described above, whereby inference performance can be assessed on a sample-by-sample basis for further data samples at a federation node.

Steps 31 to 35 of the FIG. 3 process can be implemented, in general, at one or more node computers of a federation system. Preferred embodiments implement this process for all node computers of the system, whereby performance of all models can be assessed, on a per-sample basis, in relation to a federation-based standard. Operation of preferred embodiments is described in more detail in the following.

FIG. 4 illustrates component modules in a node computer 2 of system 1, showing basic modules involved in a first embodiment of the model-based FL process. As illustrated, computer 2 comprises system memory 40 which stores the local ML model 3, and control logic indicated generally at 41. Control logic 41 comprises a model controller 42 and an FL controller 43. The model controller 42 includes an inference module 44, which controls inference operations using ML model 3, and a training/adjustment module 45. In some embodiments of system 1, module 45 may pretrain the model 3 using siloed training data 46 available to this particular federation node. Model training can be performed in well-known manner, e.g., via a supervised learning process. Here, the training data 46 comprises a set of labelled data samples for which the correct classification/regression output is known and indicated by a “label” associated with each training sample. Training involves an iterative process in which training samples are supplied to the model, and an output error is calculated based on difference between the actual model output and the ground truth label. The model parameters, such as weights in a neural network model, are then updated to mitigate the error. Training continues until a stop criterion, e.g., a desired model accuracy in a cross-validation process, is satisfied, whereupon the trained model is deployed for inference at the node computer. Module 45 may make further adjustments to model parameters on occasions, e.g., via additional training phases, as described below.

When model 3 is deployed for inference, inference module 44 receives data samples for which inference is to be performed from one or more local applications 47 at the node computer. Each input sample is supplied to the model (typically in the form of a “feature vector” which represents the sample in a predetermined format used for model inputs during training and is generated by inference model 44 for the sample), to obtain the inference output, e.g., a classification, for the sample. The inference output is then returned to local application 47 as the inference result for the data sample and may be output to a user or otherwise used by application 47 depending on the use scenario. In addition, for at least some data samples processed by model 3, model controller 42 provides the sample (or feature vector) and the inference output for that sample to FL controller 43. The FL controller provides functionality for communication with control server 5 in this embodiment. In particular, FL controller implements the necessary communications protocols for communicating with server 5, and can also implement security protocols (e.g., data privacy and/or encryption protocols) for ensuring confidentiality of communications to the extent required in the federation system.

Functionality of logic modules 42 through 45 may be implemented, in general, by software (e.g., program modules) or hardware or a combination thereof. Functionality described may be allocated differently between system modules in other embodiments, and functionality of one or more modules may be combined.

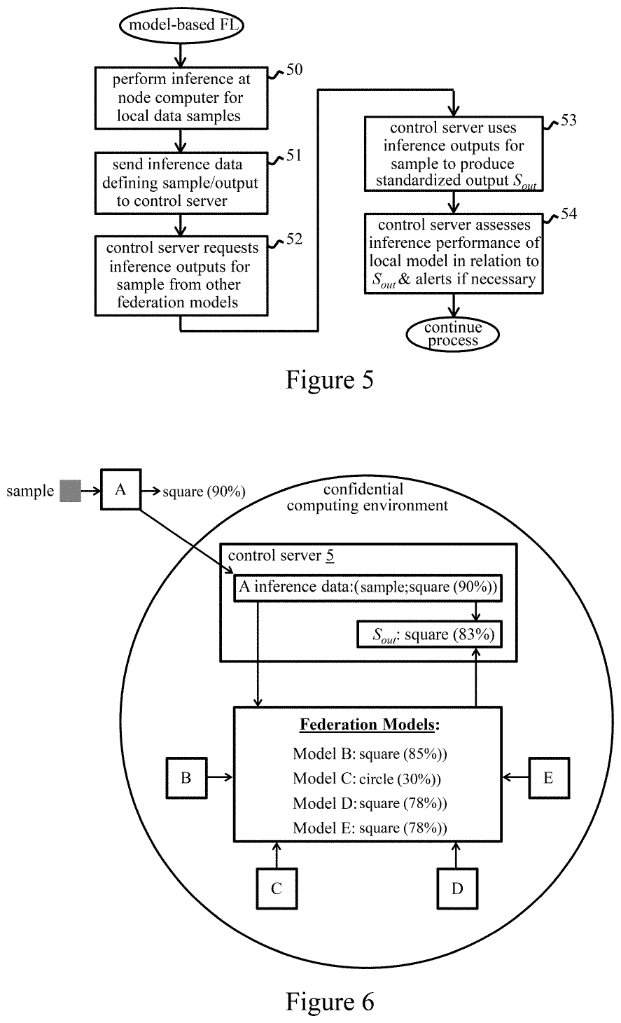

FIG. 5 indicates steps involved in the model-based FL method of this embodiment. In each node computer 2 of the system, inference module 44 performs inference for local data samples as indicated at step 50. The inference outputs from local model 3 for these samples are used locally as inference results as described above. For at least some of these data samples, model controller 42 provides the data sample (or feature vector) and the inference output for this sample to FL controller 43. In step 51, the FL controller then sends inference data, which defines that sample and the inference output, to control server 5. In step 52, the control server uses the received inference data to request at least a subset of the other federation nodes to provide an inference output corresponding to that data sample from their local federation models. The inference module 44 at each of these nodes then obtains an inference output from the local model 3, and the local FL controller 43 returns this output to control server 5.

In step 53, control server 5 uses the inference outputs from the federation models to produce a standardized inference output Sₒᵤₜ corresponding to the input data sample in question. This standardized output Sₒᵤₜ can be produced as a function of all the inference outputs from the federation models for the sample. Various functions can be envisaged here. For classification models, for example, Sₒᵤₜ may be determined by a majority vote among the classification outputs of the various models. For regression models, Sₒᵤₜ may be calculated as an average (e.g., a mean) derived from the values output by the models. Where federation models indicate a confidence value associated with an inference output (as is typically the case for ML models), determination of Sₒᵤₜ may depend on the confidence values associated with the model outputs. For example, only outputs above a threshold confidence level may be used and/or regression values may be weighted by confidence to obtain Sₒᵤₜ as a weighted average. A confidence value for Sₒᵤₜ itself may also be calculated, e.g., as an average of the confidence values for the contributing model outputs.

In step 54, control server 5 assesses performance of the model at the node which sent the inference data (step 51) in relation to the standardized output Sₒᵤₜ. In this embodiment, the control server checks whether the model output, as defined by the received inference data, deviates in a predetermined manner from Sₒᵤₜ, and alerts the node computer if so. Various alert criteria may be defined here, e.g., that the model output corresponds to a different classification to Sₒᵤₜ, a regression output deviates by more than a threshold amount from Sₒᵤₜ, or the confidence value for the model output differs by more than a threshold amount from that calculated for Sₒᵤₜ. Suitable alert criteria can be defined as desired for a given federation task.

An alert may be handled in various ways at a node computer 2. Control server 5 may send Sₒᵤₜ to the node computer, and module 45 may adjust parameters of local model 3 accordingly. For example, module 45 may use Sₒᵤₜ as a training label for the input sample in a training stage for the model or may otherwise adjust the local model parameters so as to mitigate deviation of the model output from Sₒᵤₜ.

The FIG. 5 process continues as described above for local inference samples at federation nodes. By comparing local inference results with a federation-based standard on a sample-by-sample basis, this system allows monitoring of federation nodes to ensure that all comply with federation requirements, with the opportunity for transfer learning by adjustment/training of local models for more mutually-consistent operation. This is useful in various scenarios where federation members maintain private models but wish to ensure comparable model performance. The technique can also be applied to advantage where node computers 2 comprise edge devices in a communications network. Such devices, e.g., mobile phones, IoT devices, etc., often have limited computing power and intermittent network connection. ML models on edge devices therefore need to work offline where necessary. Moreover, deployment of a single global model on all edge devices can lead to poor performance where the training data for the global model is not representative of local data samples at all edge devices, e.g., due to variations associated with different geographical locations.

FIG. 6 illustrates operation of the above process for a simplistic example in which a federation of models (represented here by models A through E) are deployed at respective smart phones for an image classification task. Model A classifies an image (a grey square in the simple example here) as “square” with a confidence of 90% and sends its inference data to the control server. The control server communicates with other federation nodes to obtain inference outputs from models B through E as illustrated. Based on a majority vote, a standardized output is determined as Sₒᵤₜ=square with an (averaged) confidence of 83%. Note that model C produced an incorrect classification of “circle” here, but this result is overruled by majority vote. The system thus operates to build robustness in the federation via the majority voting. Note also that all operations within the environment represented by the circle in the figure may be performed in a confidential manner. Control server 5 and FL controller 43 at federation nodes can implement various protocols to protect privacy and confidentiality of data communicated in the system. For example, inference data can be encrypted at nodes prior to transmission, and known cryptographic techniques can be employed to allow necessary operations to be performed by the control server and other federation nodes without revealing the raw input data (original plaintext) to these parties. Various cryptographic techniques, such as homomorphic encryption, can be exploited to implement such a confidential computing environment. Techniques other than encryption can also be envisaged for processing raw input data samples at nodes to produce inference data defining that sample such that the raw input data is hidden in the inference data. For example, data samples (or original feature vectors) can be transformed into a vector in some latent space such that other federation parties can process the resulting vector without extracting the original input data. One or a combination of such techniques can be employed to ensure a required level of data confidentially/security in the system.

In some embodiments, steps 51 to 54 of FIG. 5 may be performed for all data samples on which inference is performed locally at a node. In other embodiments, these steps may be performed for selected samples only, e.g., every n^{th} sample processed locally, to reduce processing required for system implementation. In systems where nodes have intermittent network connection, these steps may be performed for samples processed when a given node device is online. Also, the number of other federation nodes consulted in step 52 can be determined as desired for a given federation. For example, all nodes, or all on-line nodes, may be consulted in some scenarios, or a specified number of nodes may be consulted to ensure that standardized outputs are adequately representative.

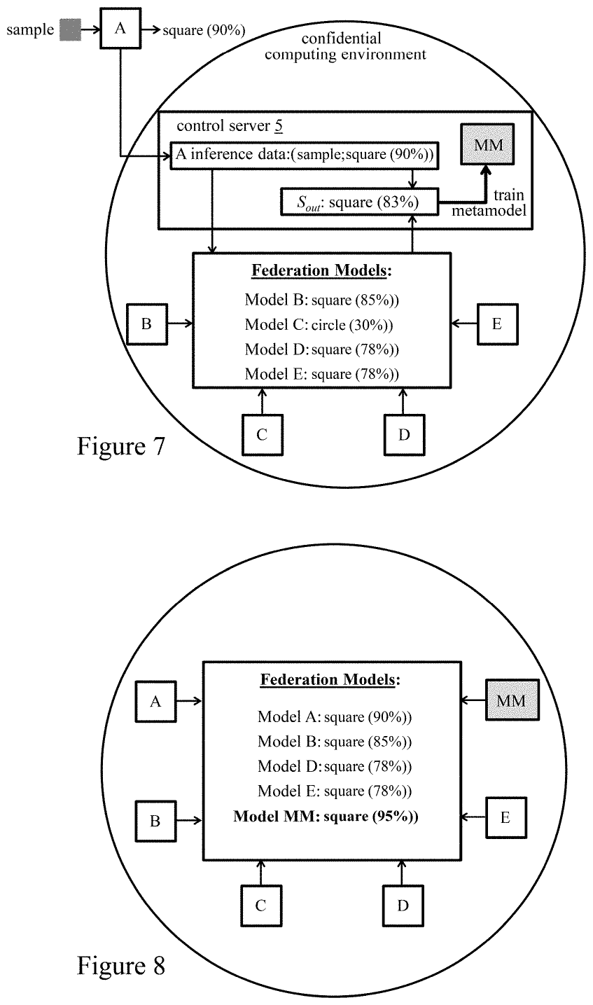

FIGS. 7 and 8 illustrate a modification to the FIG. 5 process in relation to the example from FIG. 6. In this embodiment, as shown in FIG. 7, control server 5 uses the inference outputs from the federation models corresponding to each data sample to train a metamodel (MM). For example, a training sample can be generated using the data sample defined by the inference data with the standardized output Sₒᵤₜ as the training label. The metamodel can be trained on multiple such samples in a preliminary operating phase of the system. After sufficient training, the metamodel can then be deployed in the federation. Thereafter, the standardized inference output Sₒᵤₜ for a data sample may be produced at the control server by obtaining an inference output from at least the metamodel. As illustrated in FIG. 8, by training the metamodel based on outputs of multiple federation models, the metamodel can be expected to outperform any individual federation model. The metamodel output can thus serve as a benchmark for the federation models. The metamodel output may then be used (alone or in combination with other model outputs as above) to produce Sₒᵤₜ at control server 5. Metamodel training may also continue based on subsequent federation model outputs if desired. In some embodiments, the metamodel may also be deployed at a federation node if the local model is deemed to be inadequate.

The above systems provide effective techniques for multi-model monitoring and benchmarking in federations of models, enabling comparable model performance to be ensured across a federation. Benchmarking is important in numerous application scenarios to ensure mutually-consistent performance of different federation models. In the healthcare industry, for example, it can be critical for private models at different institutions to produce consistent results. Regulation in other industries, such as banking and other financial, commercial or industrial applications, often requires distributed models to meet industry performance benchmarks. Moreover, models at individual nodes can be improved based on better-performing models at other nodes, allowing models to benefit from each other's learning. In addition, by assessing model performance using a standardized output derived from a plurality of federation models, the system is protected from so-called poisoning by any one federation model. If one federation node (intentionally or otherwise) injects bad results into the system, this will be mitigated by the standardization process.

While a federation control server 5 is provided in embodiments above, systems can be envisaged in which nodes can communicate directly with other federation nodes. Operations performed by the control server above may be implemented by individual federation nodes in these systems. For example, nodes may include local functionality for generating a standardized output Sₒᵤₜ for their inference samples.

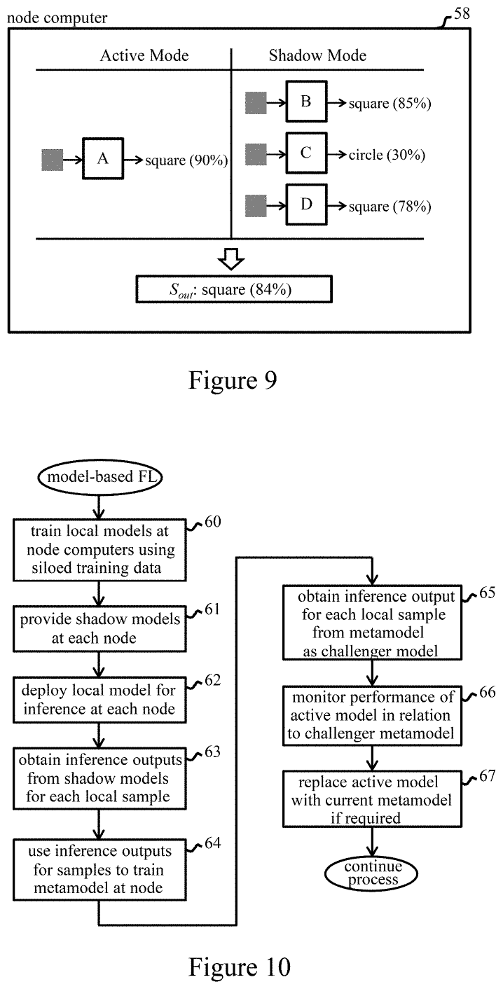

Another implementation of a model-based FL method will now be described with reference to FIGS. 9 to 11. The FIG. 9 schematic indicates operation of a federation node in this embodiment. Here, a node computer 58 deploys its own model (here model A) for inference at that node, generally as described for local models 3 above. In addition, the node computer stores at least a subset of the other federation models, here models B, C and D. When model A performs inference on a local data sample, node computer 58 also obtains inference outputs from each of the other models B, C and D. While outputs from model A are used as inference results by a local application, the inference outputs from the other models are not output to this application. Instead, the outputs of models B, C and D are used (alone or in combination with the model A output) to produce a standardized inference output Sₒᵤₜ corresponding to each local data sample. Model A thus operates in an “active mode”, while the other models operate in a “shadow mode”. The standardized output Sₒᵤₜ can be produced generally as described above, and is used as previously to provide a benchmark for assessing inference performance of the active model A. In the classification example shown here, Sₒᵤₜ is produced by majority vote with an average of the confidence values from the contributing model outputs.

Node computer 58 may compare the standardized output Sₒᵤₜ with the inference output of the active model, and if the active model output deviates in a predetermined manner from Sₒᵤₜ, the node computer may adjust parameters of the active model to alleviate the deviation. For example, the active model may be further trained based on the inference outputs from the shadow models, e.g., using Sₒᵤₜ as a training label for the data samples.

FIG. 9 indicates more-detailed steps of a preferred embodiment based on this system. As indicated at step 60, federation models are trained at respective federation nodes based on local siloed training datasets. At step 61, trained models are shared between nodes such that each node stores a set of the other federation models for use in shadow mode. The number of shadow models can be determined based on federation requirements and may be specified by a regulatory authority for assuring comparable model performance in the federation. The locally-trained model is deployed for inference in step 62. As indicated at step 63, for each local data sample processed by the active model, inference outputs are obtained from the shadow models. At least in a preliminary operating phase of the system, the resulting inference outputs for samples are used to train a local metamodel as indicated at step 64. For example, the metamodel may be trained using the standardized output Sₒᵤₜ as the training label for a sample. Hence, the shadow models are used here as “teacher” models the outputs of which are used in training a “student” metamodel. After sufficient training, the metamodel is deployed as a “challenger” to the active local model. In particular, as indicated at step 65, an inference output is obtained from the metamodel for each local data sample processed by the active model. This metamodel output (alone or in combination with outputs of the other shadow models) may be used to provide the standardized output Sₒᵤₜ from this point. Subsequently, as indicated at step 66, the node computer monitors performance of the active model in relation to that of the challenger metamodel. If performance of the active model deviates in a predetermined manner from that of the metamodel (e.g., if a predetermined performance criterion, indicating that the challenger is outperforming the active model, is satisfied), the active model is replaced by the challenger metamodel as indicated at step 67. Operation then continues using the current version of the metamodel as the active model. Model training can also continue using the shadow models as teachers, whereby the further-trained metamodel continues to compete as challenger to the current active model.

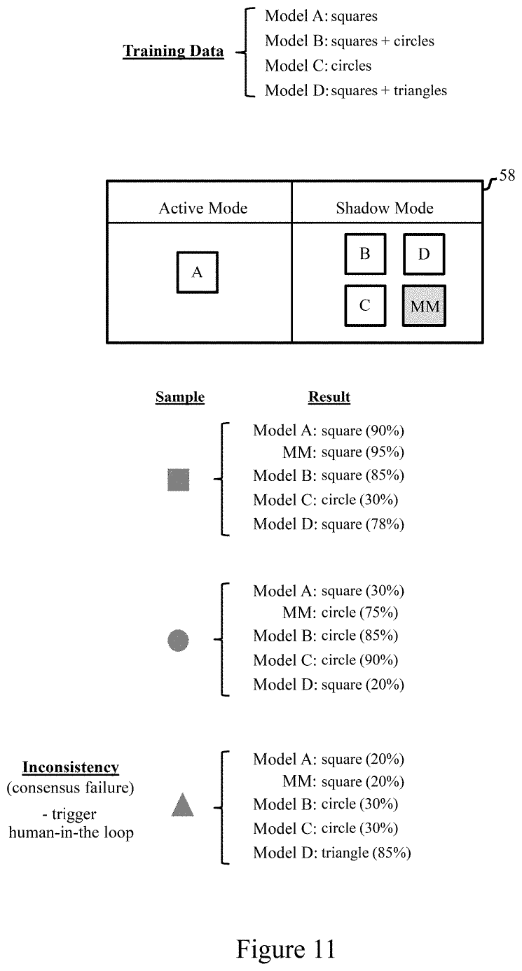

FIG. 11 illustrates operation of the FIG. 10 process with reference to a simple image classification example. Each model A through D is trained on different training data as indicated. After training, the metamodel performs well on a wider range of input samples than the active model. As indicated at the bottom of the figure, the node computer 58 can trigger a “human-in-the-loop” process on detection of a predetermined inconsistency condition indicating majority objection or failure to reach a consensus among the models. In this case, the data sample in question can be output to a human for correct labeling. The resulting human input can then be used as a training label for the sample in further training of the metamodel.

FIG. 11 demonstrates that the model-based learning system accommodates both horizontal federated learning (i.e. same classification/feature space across all models A to D), and vertical federated learning (i.e. different classification/feature space) for training a metamodel, thus providing transfer learning in which a teacher model, built to solve a different problem, can be used to train the metamodel to solve that problem without having to provide access to the teacher model's training data. This is of significant value in low resource domains and domains where data cannot be exchanged for liability and/or privacy reasons. As an example here, two civil infrastructure companies may have models trained in different domains: Company A is specialized in modern concrete bridges (90%), but also works on some old bridges (10%); Company B is specialized in old concrete bridges (90%), but also works on some new bridges (10%). The model-based FL techniques above can allow both companies to detect defects that are rare on their specialist bridges resulting in lack of local training data.

It will be seen that the above embodiments offer highly-effective systems for model-based federated learning. However, various alternatives and modifications can be made to the particular embodiments described. By way of example, features described with reference to one embodiment may be applied in other embodiments as appropriate. In general, where features are described herein with reference to a method embodying the invention, corresponding features may be provided in a system embodying the invention, and vice versa.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for federated learning among a federation of machine learning models in a computer system, the method comprising:
in at least one node computer among a plurality of node computers of the computer system, deploying a federation model for inference on local input data samples at the at least one node computer to obtain inference outputs for the local input data samples, and providing the inference outputs for use as inference results at the at least one node computer;
in the computer system, for at least a portion of the local input data samples, obtaining the inference outputs from at least a subset of other federation models; and
in the computer system, using the inference outputs to provide a standardized inference output corresponding to the local input data samples at the at least one node computer for assessing performance of the federation model deployed on the at least one node computer.

2. The method as claimed in claim 1, further comprising:
in each node computer among of the plurality of node computers of the computer system, deploying a respective federation model for inference on the local input data samples corresponding to a node computer among the plurality of node computers to obtain inference outputs for the local input data samples, and providing the inference outputs for use as the inference results at the node computer;
in the computer system, for at least the portion of the local input data samples at each node computer, obtaining the inference outputs from at least a subset of respective federation models based on the respective federation model in each node computer; and
in the computer system, using the inference outputs from the at least the subset of the respective federation models to provide the standardized inference output corresponding to the local input data samples corresponding to each node computer for assessing performance of each respective federation model deployed on each node computer.

3. The method as claimed in claim 2, wherein said each node computer comprises respective edge devices in a data communications network.

4. The method as claimed in claim 2, further comprising:
producing the standardized inference output corresponding to a respective input data sample as a function of the inference outputs from each respective federation model for the respective input data sample.

5. The method as claimed in claim 4, wherein the standardized inference output comprises one of a majority vote and an average derived from the inference outputs from each respective federation model.

6. The method as claimed in claim 4, wherein the inference outputs of each respective federation model indicate a confidence value associated with a respective inference output, and wherein producing the standardized inference output from the inference outputs based on each respective federation model is dependent on the confidence value associated with the inference outputs.

7. The method as claimed in claim 2, further comprising:
at least in a preliminary operating phase of the computer system, using the inference outputs from each respective federation model corresponding to the respective input data sample to train a metamodel in the federation of machine learning models; and
in response to training the metamodel, obtaining the inference outputs for the input data samples from at least the metamodel to provide the standardized inference output corresponding to the respective input data sample.

8. The method as claimed in claim 4, wherein the computer system comprises a control server for communication with the plurality of node computers via a data communications network, and wherein the method further comprises:
at each node computer, sending to the control server inference data, defining the respective input data sample and corresponding inference output for the respective input data sample from each node computer;
at the control server, using the inference data to request the corresponding inference output for the respective input data sample from the subset of the respective federation models on the plurality of node computers; and
at the control server, using the inference outputs from the subset of the respective federation models to provide the standardized inference output corresponding to the respective input data sample at each node computer.

9. The method as claimed in claim 8, further comprising:
at the control server, alerting the node computer in response to the inference output defined by said inference data deviates in a predetermined manner from the standardized inference output corresponding to the respective input data sample defined by the inference data.

10. The method as claimed in claim 8, further comprising:
at each node computer, processing a raw input data sample to produce the inference data defining the raw input data sample such that the raw input data sample is hidden in the inference data.

11. The method as claimed in claim 1, further comprising, in the at least one node computer of the system:
storing the at least the subset of the other federation models;
obtaining the inference outputs from the at least the stored subset of the other federation models for the local input data samples in the at least one node computer; and
using the inference outputs from the at least the stored subset of the other federation models to produce the standardized inference output corresponding to each input data sample associated with the local input data samples.

12. The method as claimed in claim 11, wherein the standardized inference output comprises one of a majority vote and an average derived from the inference outputs.

13. The method as claimed in claim 11, further comprising, in the at least one node computer:
comparing the standardized inference output with an inference output from the inference outputs of the deployed federation model for inference at the at least one node computer; and
in response to determining that the inference output of the deployed federation model deviates in a predetermined manner from the standardized inference output, training the deployed federation model using the inference outputs from the at least the stored subset of the other federation models.

14. The method as claimed in claim 1, further comprising, in the at least one node computer:
storing the at least the subset of the other federation models;
obtaining the inference outputs from the at least the stored subset of the other federation models for the local input data samples at the at least one node computer;
at least in a preliminary operating phase of the computer system, using the inference outputs from the other stored models for each data sample to train a metamodel included in the federation of models; and
in response to training the metamodel, obtaining the inference outputs for each local input data sample from at least the metamodel to provide the standardized inference output.

15. The method as claimed in claim 14, further comprising, in the at least one node computer:
comparing performance of the deployed federation model for inference on received input data samples with performance of the metamodel for the received input data samples; and
in response to determining that performance of the deployed federation model deviates in a predetermined manner from the performance of the metamodel, replacing the deployed federation model with the metamodel.

16. The method as claimed in claim 11, further comprising, in each node computer associated with the plurality of node computers of the computer system:
deploying a respective federation model for inference on the local input data samples at a node computer associated with the plurality of node computers to obtain inference outputs for each local input data sample corresponding to the local input data samples, and providing the inference outputs for use as inference results at the node computer;
storing the at least the subset of the other federation models;
obtaining the inference outputs from the at least the stored subset of the other federation models for the local input data samples at the node computer; and
using the inference outputs from the respective federation model and the inference outputs from the at least the stored subset of the other federation models to produce the standardized inference output corresponding to each local input data sample.

17. A computer system for federated learning among a federation of machine learning models, comprising:
at least one node computer deploying a federation model for inference on local input data samples at the at least one node computer to obtain inference outputs for the local input data samples, and to provide the inference outputs for use as inference results at the at least one node computer; and
for at least a portion of the local input data samples, obtaining the inference outputs from at least a subset of other federation models, and using the inference outputs from the deployed federation model and the subset of the other federation models to provide a standardized inference output corresponding to a local input data sample at the at least one node computer and for assessing performance of the deployed federation model at the at least one node computer.

18. The computer system as claimed in claim 17 comprising:
a plurality of node computers, with each node computer among the plurality of node computers deploying a respective federation model for inference on the local input data samples corresponding to a node computer to obtain an inference output for each local input data sample, and to provide the inference outputs for use as inference results at the node computer;
a control server communicating with the plurality of node computers via a data communications network; and
with each node computer sending to the control server inference data and defining an input data sample and inference output for the inference data sample at the node computer, wherein the control server uses the inference data to request the inference output corresponding to the input data sample from the at least the subset of the other federation models at other node computers, and uses the inference outputs from the at least the subset of the other federation models to provide the standardized inference output corresponding to the input data sample at each node computer.

19. The computer system as claimed in claim 17, further comprising, for the at least one node computer:
storing the at least the subset of the other federation models;
obtaining the inference outputs from the at least the stored subset of the other federation models for the local input data samples at the at least one node computer; and
using the inference outputs from the at least the subset of the other federation models to produce the standardized inference output corresponding to each local input data sample.

20. The computer system as claimed in claim 17, further comprising:
at least in a preliminary operating phase of the computer system, using the inference outputs from the at least the subset of the other federation models for each data sample to train a metamodel in the federation of machine learning models; and
in response to training the metamodel, obtaining for a local input data sample at the at least one node computer, an inference output from at least the metamodel to provide the standardized output corresponding to the local input data sample.
